(19) United States
(12) Patent Application Publication
(10) Pub. No.: US 2015/0356942 A1
(43) Pub. Date: Dec. 10, 2015

(54) VOLTAGE CONTROL CIRCUIT OF DISPLAY DEVICE, AND THE DISPLAY DEVICE

(71) Applicant: SAMSUNG DISPLAY CO., LTD., Yongin-City (KR)

(72) Inventors: Eiji KANDA, Yokohama (JP); Takeshi OKUNO, Yokohama (JP); Masayuki KUMETA, Yokohama (JP); Daisuke KAWAE, Yokohama (JP); Ryo ISHII, Yokohama (JP)

(21) Appl. No.: 14/734,423

(22) Filed: Jun. 9, 2015

(30) Foreign Application Priority Data
Jun. 10, 2014 (JP) 2014-119827

(51) Int. Cl. G09G 3/36

(52) U.S. Cl. CPC G09G 3/3696; G09G 2330/021

(57) ABSTRACT

A voltage control circuit of a display device includes a first power line, a second power line, a third power line, and a filter circuit. The second power line is connected to the first power line at a central portion of a predetermined area. The third power line is in the predetermined area. The filter circuit is between the second and third power lines, and includes at least one element having a larger resistance value per unit length than a resistance value per unit length of at least one of the second or third power lines.

### CROSS-REFERENCE TO RELATED APPLICATION

Japanese Patent Application No. 2014-119827, filed on Jun. 10, 2014, in the Japanese Patent Office, and entitled, “Voltage Control Circuit of Display Device, and the Display Device,” is incorporated by reference herein in its entirety.

### BACKGROUND

1. Field

One or more embodiments described herein relate to a display device and a voltage control circuit of a display device.

2. Description of the Related Art

A variety of flat panel displays have been developed. One type of display generates images using pixels that have organic electro-luminescence (EL) elements. Organic EL elements are self-emitting devices and thus are different from liquid crystal and other types of display elements.

An active matrix-driven EL display uses pixel circuits to control light emission gradation of its pixels. In each pixel circuit, light emission gradation is set based on voltage and current values that control the driving current for the EL element. The driving current may be applied to the organic EL element by a power supply circuit. In operation, a voltage drop may occur in a power line between the power supply circuit and the pixel circuit. The voltage drop reduces the voltage to be applied to the organic EL element. As a result, light emission luminance of the EL element is degraded and overall luminance of the display becomes non-uniform.

One technique for attempting to compensate this voltage drop involves detecting the voltage of the power line and generating a corrected data voltage based on the detected power line voltage. However, this technique has proven inadequate for in a number of ways. For example, it is difficult to quickly correct data using this technique because of the delay involved in reading the voltage of the power line and then feeding back the read voltage in sufficient time to perform correction.

In addition, even though the entire pixel voltage distribution in an image of a current frame may be known, the voltage distribution in an image of the next frame may have to be calculated. In this case, it may be difficult to complete this calculation in sufficient time for the next frame.

In addition, even though a voltage distribution at an anode may be known, it may be difficult to determine the voltage distribution at the cathode. A voltage applied to an organic EL element, however, is based on voltages of both the anode and cathode, e.g., based on a voltage difference between the anode and cathode. Therefore, it is insufficient to know only the voltage distribution at the anode.

### SUMMARY

In accordance with one or more embodiments, a voltage control circuit of a display device includes a first power line; a second power line connected to the first power line at a central portion of a predetermined area; a third power line in the predetermined area; and a filter circuit between the second and third power lines, wherein the filter circuit includes at least one element having a larger resistance value per unit length than a resistance value per unit length of at least one of the second or third power lines.

The first and second power lines may be formed with an identical line layer. The first and third power interconnections may be formed with different line layers. The first and second power lines may be on an identical plane and contact only at a contact point, and the first and third power lines may be on different planes in an intersected manner. The element may include a transistor. The predetermined area may be an active area for displaying an image, and a voltage applied to a gate of the transistor may be based on a light emitting area of the active area.

The predetermined area may be an active area for displaying an image, and the central portion may be between one end of the active area and a position spaced from the one end by substantially a quarter of a width of the active area. The predetermined area may be an active area for displaying an image, and the third power line may be connected to a pixel circuit in a matrix form in the active area. The predetermined area may be an area which includes periphery corner parts of the active area for displaying an image. The element may include a diode, a resistor, or a transistor in a diode-connected state.

In accordance with one or more other embodiments, a display device includes a first power line; a second power line connected to the first power line at a central portion of a predetermined area; a third power line in the predetermined area; a filter circuit between the second and third power lines, wherein the filter circuit includes at least one element having a larger resistance value per unit length than a resistance value per unit length of at least one of the second or third power lines; and a pixel connected to the third power line.

In accordance with another embodiment, an apparatus includes a first connection; a second connection; and a filter circuit between the first and second connections, wherein the first connection connects the filter circuit to a first power line and the second connection connects the filter circuit to a second power line, and wherein the filter circuit includes at least one element having a larger resistance value per unit length than a resistance value per unit length of at least one of the first or second power lines.

The first connection may include a plurality of first lines, the second connection may include a plurality of second lines, and the second lines may be connected to a respective number of pixel circuits. A number of the first lines may equal a number of the second lines. The first connection may be connected between the filter circuit and a third signal line in an active area for displaying an image. The first connection may be connected to the third signal line at substantially a central location of the active area. The element may include a transistor. The element may include a diode or resistor.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates an embodiment of a display circuit;

FIG. 3A illustrates an enlarged portion A in FIG. 2, FIG. 3B illustrates an embodiment of a pixel circuit, and FIG. 3C illustrates another embodiment of a pixel circuit;

FIG. 4 illustrates voltage values between anode and cathode lines;

FIG. 5 illustrates current between the anode and cathode lines;

FIG. 6 illustrates an example of an ideal value of a voltage for the EL element;

FIG. 7 illustrates an example of a voltage value between the anode and cathode lines when power is supplied in a horizontal direction of the anode line;

FIG. 8 illustrates an example of currents between the anode and cathode lines when power is supplied in a horizontal direction of the anode line;

FIG. 9A illustrates an example of a voltage distribution of an anode line, and FIG. 9B illustrates an example of current between anode and cathode lines;

FIG. 10 illustrates an embodiment of a filter circuit;

FIG. 11 illustrates an example of a voltage drop without a filter circuit;

FIG. 12 illustrates one type of a voltage drop;

FIG. 13 illustrates a voltage drop when a resistor is at the anode side of an EL element;

FIG. 14 illustrates another example of a voltage drop;

FIG. 15 illustrates an example of a voltage drop that may occur when a resistor is between adjacent pixels;

FIG. 16 illustrates another example of a voltage drop;

FIG. 17 illustrates an example of a potential difference between adjacent pixels when a filter circuit is provided and an example of voltage drop between adjacent pixels when a filter circuit is not provided;

FIG. 18 illustrates another embodiment of a pixel circuit;

FIG. 19 illustrates another embodiment of a pixel circuit;

FIG. 20 illustrates another embodiment of a pixel circuit;

FIG. 21 illustrates an example of a voltage distribution for an EL element;

FIG. 22 illustrates an example of a current distribution for an EL element;

FIG. 23 illustrates another example of a voltage distribution for an EL element;

FIG. 24 illustrates another example of a current distribution for an EL element;

FIG. 25 illustrates another example of a current distribution for an EL element; and

FIG. 26 illustrates another example of a current distribution for an EL element.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments. Like reference numerals refer to like elements throughout.

One or more embodiments described herein relate to a pixel circuit of a self-emission display device. The display device may be, for example, an organic electro-luminescence display device including organic EL elements as a light emitting elements. In another embodiment, the display may be a display device including arbitrary light emitting elements that emit light based on current driving of an inorganic EL element. In another embodiment, the display device may have pixels that include a different type of self-emissive element.

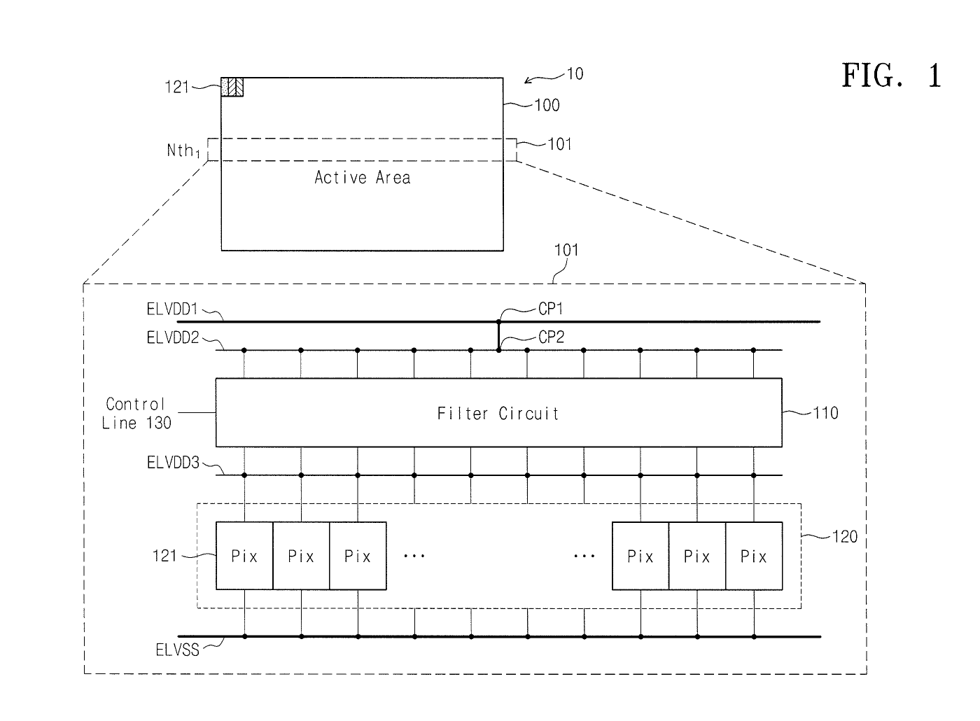

FIG. 1 illustrates an embodiment of display circuit 10 of a self-emission display device. The display circuit 10 is an example of a voltage control circuit of a display device. The display circuit 10 includes a plurality of pixel circuits 121 in a matrix shape in an active area 100 for displaying an image. An organic EL element is provided to each of the pixel circuits 121. The display circuit 10 may display an image using self-emitted light of the organic EL element based on current flowing through the pixel circuit 121.

In FIG. 1, an enlarged row 101 of the active area 100 is illustrated for convenience. Each row 101 of the active area 100 includes a filter circuit 110 and a pixel circuit unit 120. In addition, each row 101 of the active area 100 includes first to fourth power lines ELVDD1, ELVDD2, ELVDD5 and ELVSS that extend, for example, in a first (e.g., row) direction.

The first power line ELVDD1 and the second power line ELVDD2 may be formed with an identical line layer. The first power line ELVDD1 and the third power line ELVDD3 may be formed with different line layers.

The first and second power lines ELVDD1 and ELVDD2 are connected at a central region of the active area 100 in a horizontal direction. Accordingly, a voltage drop is compensated in the pixel circuit unit 120 based on routing of the power line. For example, the first and second power lines ELVDD1 and ELVDD2 contact only at a first contact point CP1 of the first power line ELVDD1 and at a second contact point CP of the second power line ELVDD2. The first and second contact points CP1 and CP2 may be defined at a position separated from one end of the active area 100 by, for example, half the width of the active area 100.

The central portion of the active area 100 in the horizontal direction may be, for example, a portion between a right end of the active area 100 and a position separated from the right end of the active area 100 by half the horizontal width of the active area 100. In another embodiment, the central portion of the active area 100 may be a portion between a left end of the active area 100 and a position separated from the left end of the active area 100 by half the horizontal width of the active area 100. In another embodiment, the central portion may be defined, for example, between positions separated from the left and right ends of the active area 100 by a quarter (or another fraction) of the horizontal width of the active area 100.

The first power line ELVDD1 is connected to the second power line ELVDD2 at a central portion of the active area 100 in the horizontal direction. In another embodiment, the first and second power lines ELVDD1 and ELVDD2 may be connected at other portions.

The filter circuit 110 is between the second power lines ELVDD2 and the third power line ELVDD3. Each pixel circuit 121 of the pixel circuit unit 120 emits light based on an amount of current flowing from the third power line ELVDD3 to the fourth power line ELVSS.

In the embodiment of FIG. 1, the filter circuit 110 is provided between the second power line ELVDD2 and the third power line ELVDD3. The filter circuit 110 controls the voltage of the third power line ELVDD3 so that a uniform voltage is applied in the horizontal direction of the active area 100. The filter circuit 110 includes a element having a greater resistance value per unit length than that of the second power line ELVDD2 or the third power line ELVDD3.

As long as a resistance value related condition is satisfied, the filter circuit 110 may be configured, for example, with transistors Tr, diodes, resistors, and/or with diode-connected transistors Tr. The filter circuit 110 is connected to a control line 130 for controlling operation of the filter circuit 110 based on light emission of pixel circuit 121.

The display circuit 10 is an example of a voltage control circuit of a display device which enables a voltage drop due to routing of the power line and luminance unevenness to be easily reduced.

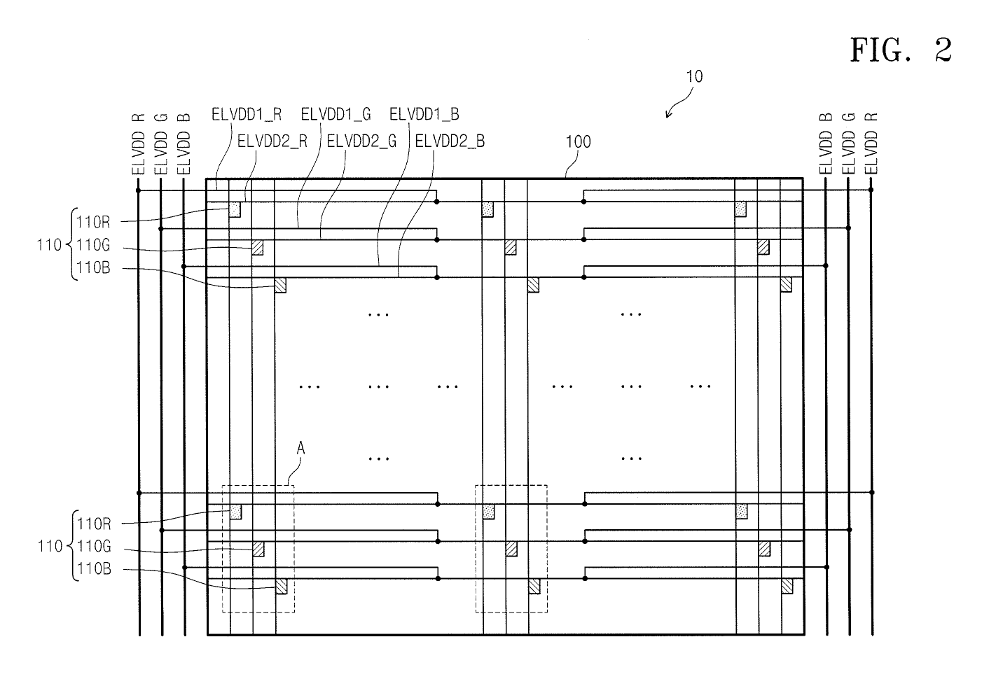

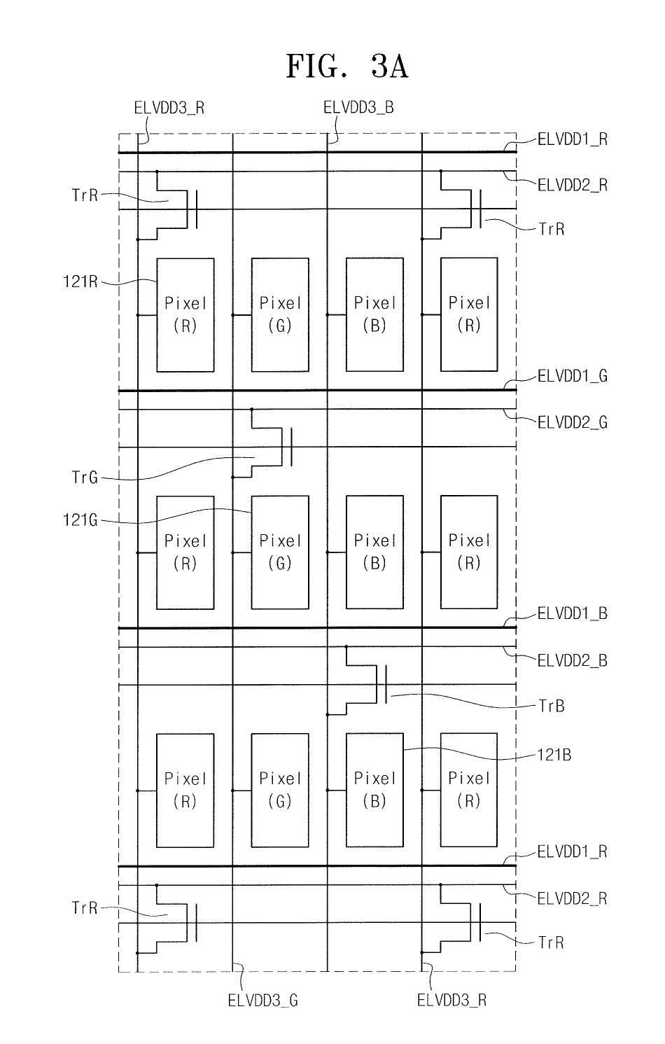

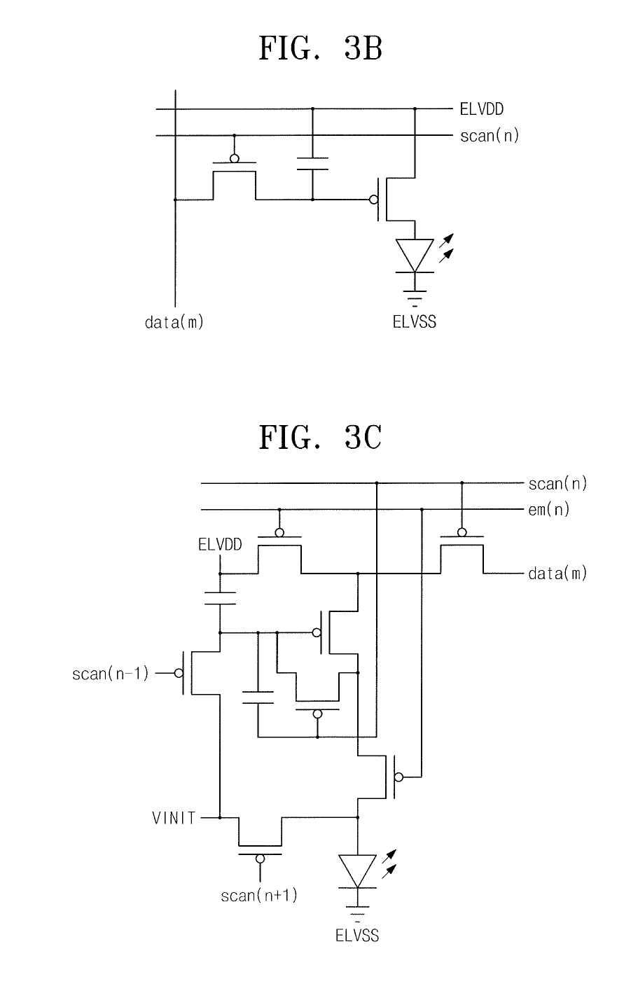

FIG. 2 illustrates an embodiment of a display circuit, which, for example, may represent a more detailed configuration of the display circuit 10 of the self-emission display device in FIG. 1. FIG. 3A illustrates an enlarged portion A of the display circuit 10 in FIG. 2.

Referring to FIGS. 2 and 3A, the display device 10 includes a plurality of pixel circuits 121 in a matrix form in the active area 100 for displaying an image. In accordance with the present embodiment, first to third power lines ELVDD1, ELVDD2, and ELVDD3 are connected to the display circuit 10.

In FIG. 2, pixel circuits of three predetermined colors are disposed in a regular pattern. For example, the pixel circuits of three primary colors (e.g., red, green, and blue) are respectively connected to the first to third power lines ELVDD1, ELVDD2, and ELVDD3. In another embodiment, the pixel circuits of three primary colors may be commonly connected to the same power line.

The power lines are located at left and right sides of the active area 100 and supply power to the active area 100 from these sides. Power lines connected to a red pixel circuit correspond to power lines ELVDD1_R, ELVDD2_R, and ELVDD3_R. Power lines connected to a green pixel circuit correspond to power lines ELVDD1_G, ELVDD2_G, and ELVDD3_G. Power lines connected to a blue pixel circuit correspond to power lines ELVDD_1_B, ELVDD2_B, and ELVDD3_B.

The power lines ELVDD1_R, ELVDD1_G, ELVDD1_B may collectively be referred to as the first power line ELVDD1. The power lines ELVDD2_R, ELVDD2_G, ELVDD2_B may collectively be referred to as the second power line ELVDD2. The power lines ELVDD3_R, ELVDD3_G, ELVDD3_B may collectively be referred to as the third power line ELVDD3.

In FIG. 3A, the third power line ELVDD3 intersects the first power line ELVDD1 on another plane. For example, the third power line ELVDD3 may extend in a column direction and the first power line ELVDD1 may extend in a row direction.

The power line ELVDD1_R is connected to the power line ELVDD2_R at the central portion of the active area 100 in the horizontal direction. The power line ELVDD1_R is connected to the power line ELVDD2_R at the central portion of the active area 100 in the horizontal direction to compensate for a voltage drop in the pixel circuit unit 120 by routing the power lines. Similarly, the power line ELVDD1_G is connected to the power line ELVDD2_G at the central portion of the active area 100 in the horizontal direction, and the power line ELVDD1_B is connected to the power line ELVDD2_B at the central portion of the active area 100 in the horizontal direction.

The power line ELVDD2_R and the power line ELVDD3_R are connected by a filter circuit 110R. The power line ELVDD2_G and the power line ELVDD3_G are connected by a filter circuit 110G. The power line ELVDD2_B and the power line ELVDD3_B are connected by a filter circuit 110B.

FIG. 3A illustrates an enlarged portion A of the display circuit 10 in FIG. 2. When portion A is enlarged, pixel circuits 121R, 121G, and 121B of three primary colors of red R, green G, and blue B are illustrated to be regularly disposed. Each of the pixel circuits 121R, 121G, and 12B includes an organic EL element emitting light when a current flows therethrough.

FIGS. 3B and 3C illustrate embodiments of the pixel circuits 121R, 121G, and 121B. In other embodiments, the pixel circuits 121R, 121G, and 121B may be constant voltage driving pixel circuits having another configuration or constant current driving pixel circuits.

The power line ELVDD2_R and the power line ELVDD3_R are connected through transistor TrR. The transistor TrR performs the function of the filter circuit 110R in FIG. 2. The power line ELVDD2_G and the power line ELVDD3_G are connected through transistor TrG, which performs the function of the filter circuit 110G. The power line ELVDD2_B and the power line ELVDD3_B are connected through transistor TrB, which performs the function of the filter circuit 110B.

In FIG. 3A, the transistor TrR is between the power line ELVDD2_R and the power line ELVDD3_R, the transistor TrG is between the power line ELVDD2_G and the power line ELVDD3_G, and the transistor TrB is between the power line ELVDD2_B and the power line ELVDD3_B. Thus, according to one embodiment, the display circuit 10 enables a voltage drop due to routing of the power line and luminance unevenness to be easily reduced.

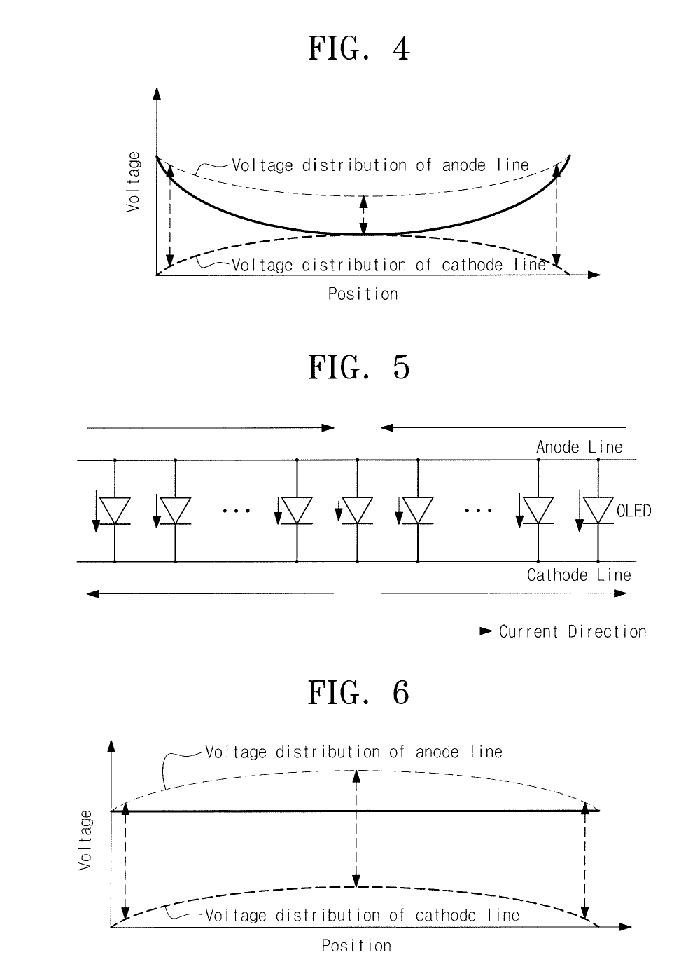

FIG. 4 is a graph representing a voltage value between an anode line and a cathode line of an organic EL element OLED, when the first power line ELCDD1 is not connected to the second power line ELFDD2 at the central portion of the active area 100 in the horizontal direction, which is not like display circuit 10. In FIG. 4, the x-axis represents the position of a horizontal direction of an active area defined based on the left end and the y-axis represents a voltage value.

FIG. 5 illustrates current flowing between an anode line and cathode line of an organic EL element. As illustrated in FIG. 5, when power is supplied to the active area, since organic EL elements are connected in parallel between an anode line and a cathode line, a voltage drop occurs in the anode line by routing the power lines when moving from an edge to the central portion of the active area. In addition, the cathode line has a voltage distribution in which a voltage is the highest at the central portion of the active area and becomes lower towards edges on both sides. Accordingly, a voltage applied to the organic EL elements is the lowest at the central portion of the active area and becomes higher moving towards the edges of both sides.

As a result, when a voltage is applied to the organic EL elements, voltages are not uniform over positions on the screen and the amount of current is lowered when provided from the central portion of the active area in the horizontal direction. Accordingly, light emission luminance and the current amount is lowered. As a result, luminance unevenness occurs.

FIG. 6 is a graph representing an ideal value of a voltage applied to an organic EL element. In FIG. 6, the solid line represents the potential difference between an anode line and a cathode line. When voltage is applied uniformly at all positions on the screen, by allowing the voltage distribution of the anode line to correspond to the voltage distribution of the cathode line, the voltage may be uniformly applied to all positions on the screen and luminance unevenness may be reduced as indicated by the solid line in FIG. 6.

In order to compensate for current amount at the central portion of the active area in the horizontal direction, the following description is provided to indicate what may happen when a new power line is prepared and connected to the central portion of the anode line in the horizontal direction.

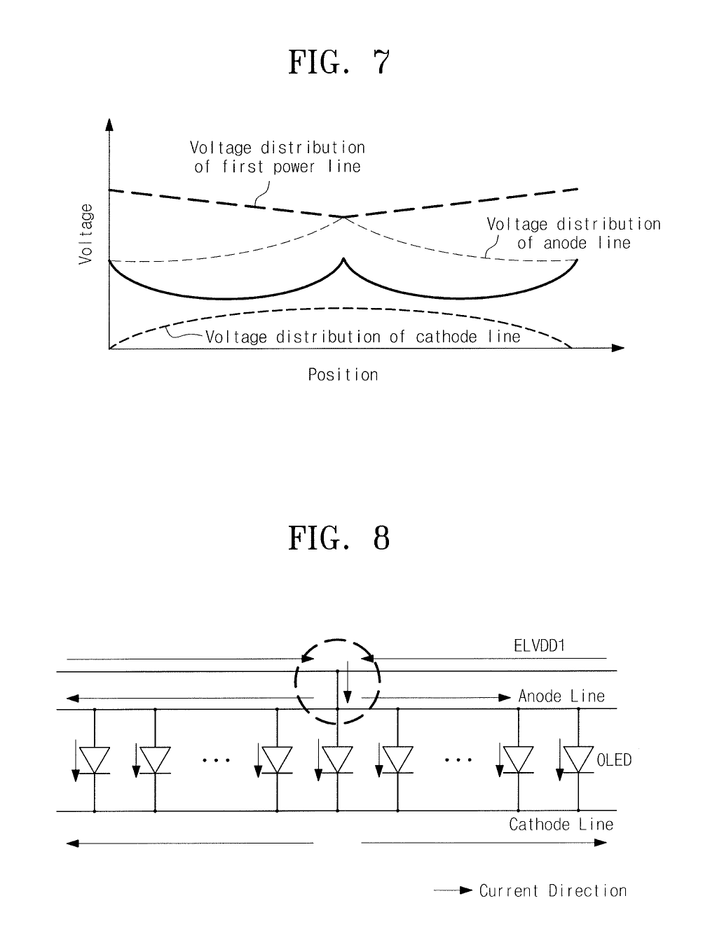

FIG. 7 is a graph representing a voltage value between an anode line and cathode line when power is supplied to a central portion in a horizontal direction of an anode line. In FIG. 7, the x-axis represents the position of a horizontal direction of an active area defined based on the left end of the active area. The y-axis represents a voltage value. FIG. 8 illustrates currents flowing between an anode line and cathode line of an organic EL element when power is supplied to a central portion in a horizontal direction of an anode line.

The voltage value at the central portion in the horizontal direction of the anode line is increased by supplying power to the central portion of the anode line in the horizontal direction through the first power line ELVDD1. Accordingly, according to one embodiment, the voltage value at the central portion in the horizontal direction of the anode line may be greater than those of both end portions of the anode line. In another embodiment, the voltage value may be the same as those of both end portions of the anode line.

The voltages between the central portion and both end portions of the anode line in the horizontal direction may have the same value as in FIG. 7. In this case, the potential difference between the anode and cathode lines may correspond to the solid line in FIG. 7. For example, the anode line has a greater current amount towards the central portion in the horizontal direction and a smaller current amount towards the end portions. In addition, a voltage drop in the anode line has a steep slope towards the central portion. A voltage distribution of the anode line is different from that of the cathode line.

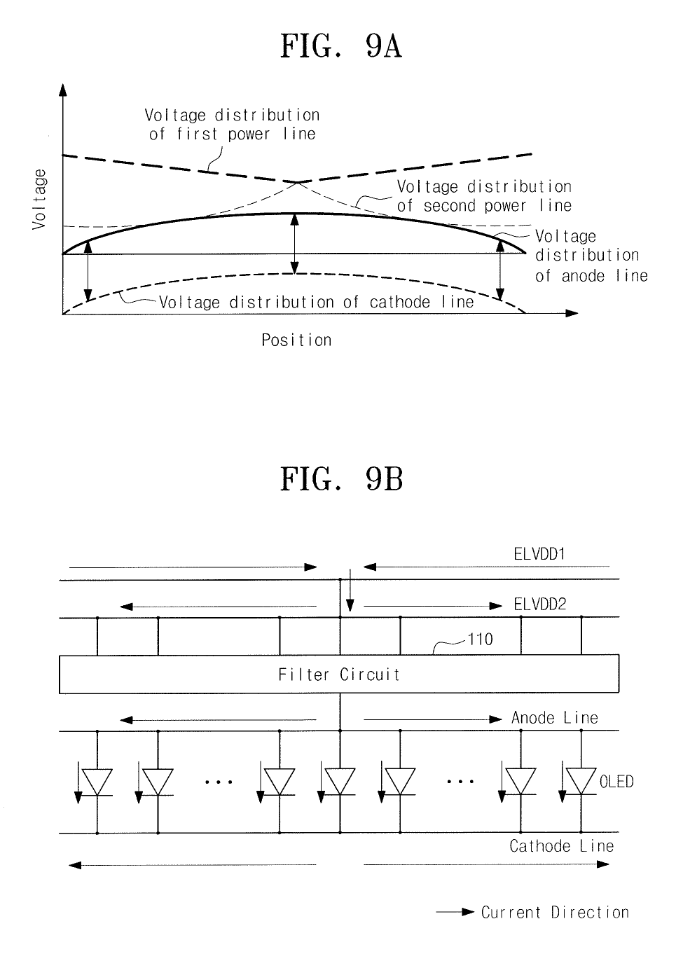

FIG. 9A illustrates an example of the voltage distribution of the anode line when the filter circuit 110 is included, and FIG. 9B illustrates examples of currents flowing between the anode and cathode lines of an organic EL element when the filter circuit 10 is included.

In FIG. 9B, the potential difference between the anode line and the cathode line has the same value (as represented by the solid line in FIG. 9A) when the voltage distribution of the anode line is gradual, as illustrated in FIG. 9A. Accordingly, the voltage distribution of the anode line may be made to have the same shape as the cathode line, and a uniform voltage may be applied to the organic EL elements at all positions of the screen.

In accordance with one embodiment, the voltage distribution of the anode line is controlled to the voltage distribution of the cathode line, and a voltage to the organic EL elements at all positions on the screen is uniformly applied. In addition, a pixel circuit for reducing unevenness of luminance uniformly applies a voltage to organic EL elements at all positions of the screen, while controlling the voltage distribution of the anode line to the voltage distribution of the cathode line.

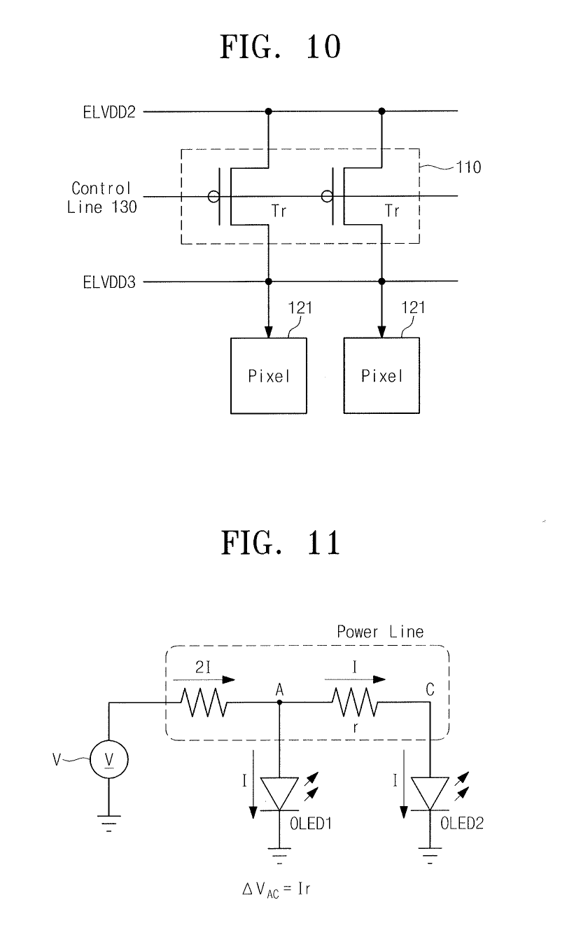

FIG. 10 illustrates an embodiment of a filter circuit 110 in the display circuit 10. As illustrated in FIG. 10, the filter circuit 110 is provided between the second power line ELVDD2 and the third power line ELVDD3. In addition, the filter circuit 110 is provided to each pixel circuit 121 and each filter circuit 110 has one transistor Tr. FIG. 10 illustrates only two pixel circuits 121 for simple explanation. In addition, the gate of each transistor Tr of the filter circuit 110 is connected to a common control line 130. A resistance value of each transistor Tr is controlled by the common control line 130.

In the embodiment of FIG. 10, the filter circuit 110 provides one transistor Tr for each pixel circuit 121. In another embodiment, one transistor Tr may be provided for a plurality of pixels. In addition, even though each transistor Tr of the filter circuit 110 is represented as a P channel transistor Tr in FIG. 10, each transistor Tr of the filter circuit 110 may be an N channel transistor Tr.

The filter circuit 110 performs the operation of matching the voltage distribution of the third power line ELVDD3, which is the anode line, with the voltage distribution of the cathode line. For example, the filter circuit 110 controls the voltage distribution of the third power line ELVDD3, which is the anode line, to have a predetermined shape, e.g., the shape in FIG. 9A.

FIG. 11 illustrates an example where a voltage drop occurs when the filter circuit 110 is not provided. In FIG. 11, two organic EL elements OLED1 and OLED2 are connected in parallel and a power supply V supplies current to the organic EL elements OLED1 and OLED2.

Because the two organic EL elements OLED1 and OLED2 are connected in parallel and line resistance between pixels is sufficiently small, currents provided to the two organic EL elements OLED1 and OLED2 by the power supply V are substantially identical. When the current flowing to the two organic EL elements OLED1 and OLED2 is 1, a voltage drop ΔV_{AC} from a point A to a point C in FIG. 11 becomes ΔV_{AC}=Ir.

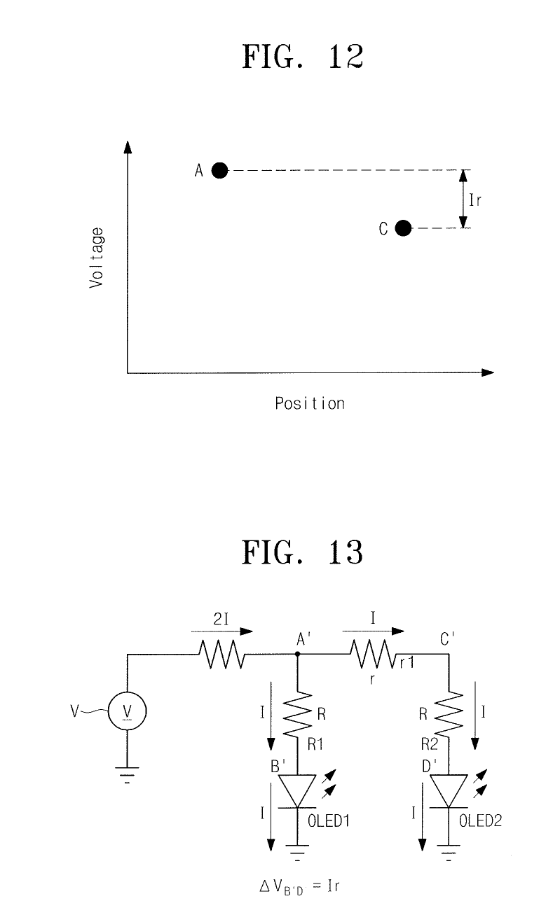

FIG. 12 is a graph illustrating an example of the voltage drop ΔV_{AC} from point A to point C. In FIG. 12, the x-axis represents a point in a horizontal direction and the y-axis represents a voltage value. In FIG. 12, the voltage drop ΔV_{AC} from point A to point C is ΔV_{Ac}=Ir.

FIG. 13 illustrates another embodiment of the filter circuit 110 in which a voltage drop occurs when a resistor is included in the anode side of an organic EL element. In FIG. 13, two organic EL elements OLED1 and OLED2 are connected in parallel and a power supply V supplies current to the organic EL elements OLED1 and OLED2. In addition, FIG. 13 illustrates a configuration in a state where a resistor R is included in each anode side of the two organic EL elements OLED1 and OLED2.

Since the two organic EL elements OLED1 and OLED2 are connected in parallel and line resistance between pixels is sufficiently small, currents provided to the two organic EL elements OLED1 and OLED2 by the power supply V are substantially identical. In addition, the resistors R are connected to the anode sides of the two organic EL elements OLED1 and OLED2. Accordingly, when the current flowing to the two organic EL elements OLED1 and OLED2 is I, since a voltage drop ΔV_{A′C′} from point A′ to point C′ in FIG. 13 becomes ΔV_{A′C′}=Ir and an identical current I flows from point A′ to point B′ and from point C′ to point D′, a potential difference ΔV_{B′D′} between point B′ and point D′ of FIG. 13 is ΔV_{B′D′}=Ir.

FIG. 14 is a graph illustrating an example of the voltage drop ΔV_{A′C′} from point A′ to point C′ and the potential difference ΔV_{B′D′} from point B′ to point D′. In FIG. 14, the x-axis represents position and the y-axis represents a voltage value. In FIG. 14, since the voltage drop ΔV_{A′C′} from point A′ to point C′ becomes ΔV_{A′C′}=Ir and the voltage drops between point A′ and point B′ and point C′ to point D′ are IR, the potential difference ΔV_{B′D′} between point B′ and point D′ is ΔV_{B′D′}=Ir.

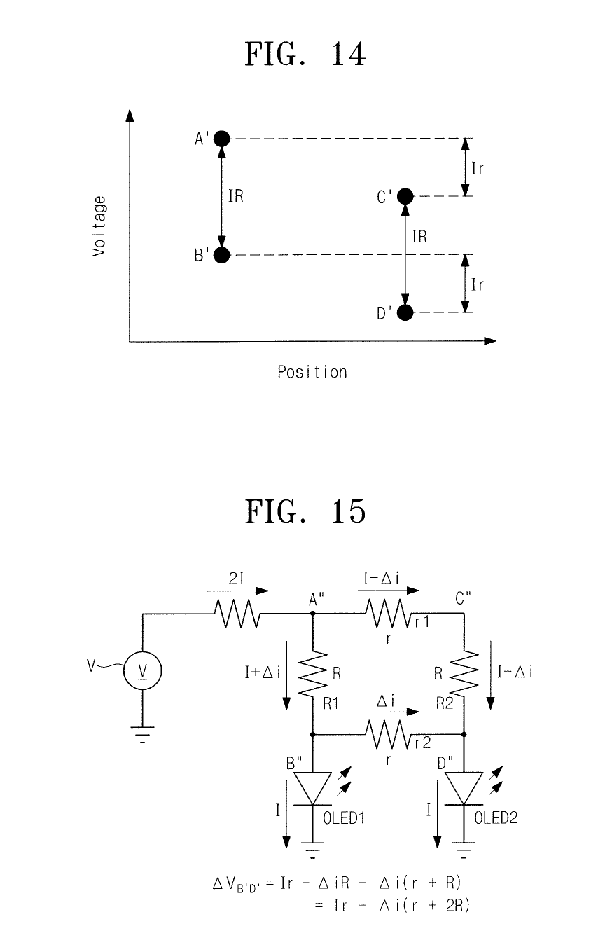

FIG. 15 illustrates an example of a voltage drop when a resistor is included between adjacent pixels. In FIG. 15, two organic EL elements OLED1 and OLED2 are connected in parallel and a power supply V supplies a current to the organic EL elements OLED1 and OLED2. In addition, FIG. 15 illustrates a configuration in a state where a resistor R is included at the anode side of each of the two organic EL elements OLED1 and OLED2. In addition, FIG. 15 illustrates a configuration in a state where the resistors R are respectively included at the anode sides of the two organic EL elements OLED1 and OLED2.

Since there is a potential between point B″ and point D″ in FIG. 15, a current Ai according to the potential flows between the points B″ and D″. In order for the current flowing to organic EL elements OLED1 and OLED2 to become I, the current flowing between the points A″ and B″ in FIG. 15 becomes I+Δi and the current flowing between the points A″ and C″ in FIG. 15 becomes I−Δi.

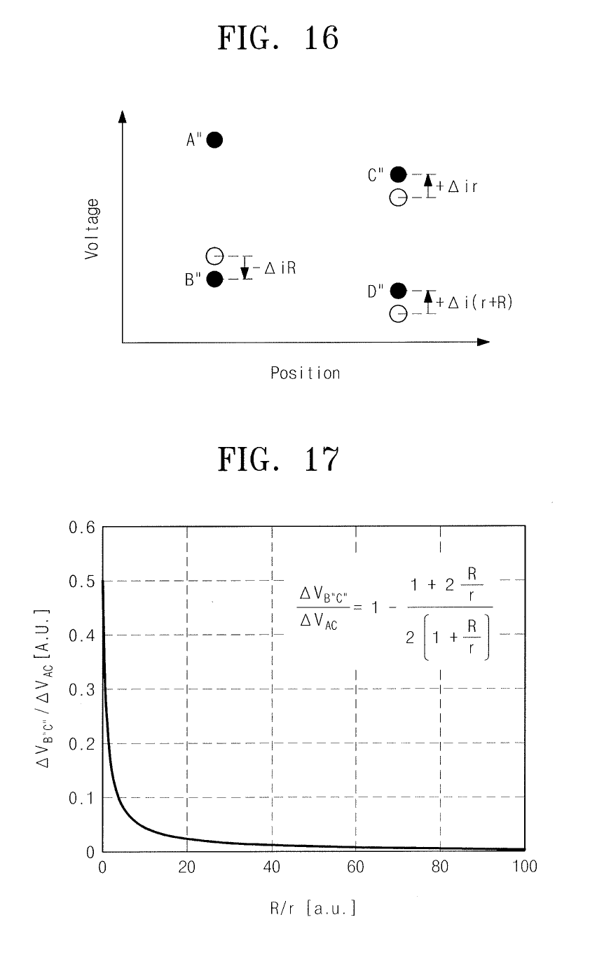

FIG. 16 is a graph illustrating an example of the voltage drop ΔV_{A″C″} between points A″ and C″ and the potential (ΔV_{B′D′}) between points B″ and D″. Compared to the configuration in FIG. 13, the potential at point B″ is reduced by MR compared to the potential of point B′ in FIG. 13. In addition, compared to the configuration in FIG. 13, the potential at point C″ is increased by MR compared to the potential of point C′ in FIG. 13. In addition, compared to the configuration in FIG. 13, the potential at point D″ is increased by Δi(r+R) compared to the potential of point D′ in FIG. 13. Accordingly, the potential difference between points B″ and D″ in FIG. 15 becomes ΔV_{B″D″}=Ir−ΔiR−Δi(R+r)=Ir−Δi(2R+r).

The voltage drop ΔV_{AC} between points A and C in FIG. 11 may be compared with the potential difference between points B″ and D″ in FIG. 15. As described above, the voltage drop ΔV_{AC} between points A and C is ΔV_{AC}=Ir. The potential difference between points B″ and D″ in FIG. 15 may be obtained by eliminating Δi by using Kirchhoff's law. The potential difference ΔVB″D″ may be expressed by Equation 1.

$$Δ {V}_{{B}^{″} {D}^{″}} = {V}_{{B}^{″}} - {V}_{{D}^{″}} = Ir ( 1 - \frac{1 + 2 \frac{R}{r}}{2 ( 1 + \frac{R}{r} )} ) \qquad ( 1 )$$

Accordingly, the relationship between the voltage drop ΔV_{AC} from point A to point C in FIG. 11 and the potential difference ΔV_{B″D″} between point B″ and point D″ in FIG. 15 may be expressed by Equation 2.

$$\frac{Δ {V}_{{B}^{″} {D}^{″}}}{Δ {V}_{AC}} = 1 - \frac{1 + 2 \frac{R}{r}}{2 ( 1 + \frac{R}{r} )} \qquad ( 2 )$$

FIG. 17 is a graph illustrating an example of a relationship between the voltage drop ΔV_{AC} between points A and C in FIG. 11 and the potential difference ΔV_{B″D″} between points B″ and D″ in FIG. 15. As represented in FIG. 17, ΔV_{B″D″}/ΔV_{AC} becomes smaller as a value of R/r is larger. Accordingly, as the value of resistor R included at the anode sides of the organic EL elements OLED1 and OLED2 is larger, the potential between point B″ and point D″ becomes smaller. In addition, as the value of resistor R is larger, the voltage for driving the organic EL element (e.g., the voltage to be supplied from the power supply V) becomes larger. Therefore it may be better in some cases to select a value (e.g., an optimal value) of the resistor R based on the size of the pixel circuit.

In this way, the voltage drop between adjacent pixels may be reduced by providing the filter circuit 110 between the second power line ELVDD2 and the third power line ELVDD3 that is an anode line. In addition, a voltage distribution of the third power line ELVDD3, that is an anode line, may be matched with the voltage distribution of the cathode line by providing the filter circuit 110 between the second power line ELVDD2 and the third power line ELVDD3.

A result of applying the filter circuit 110 between the second power line ELVDD2 and the third power line ELVDD3 that is an anode line may be compared with a case where the filter circuit 110 is not provided.

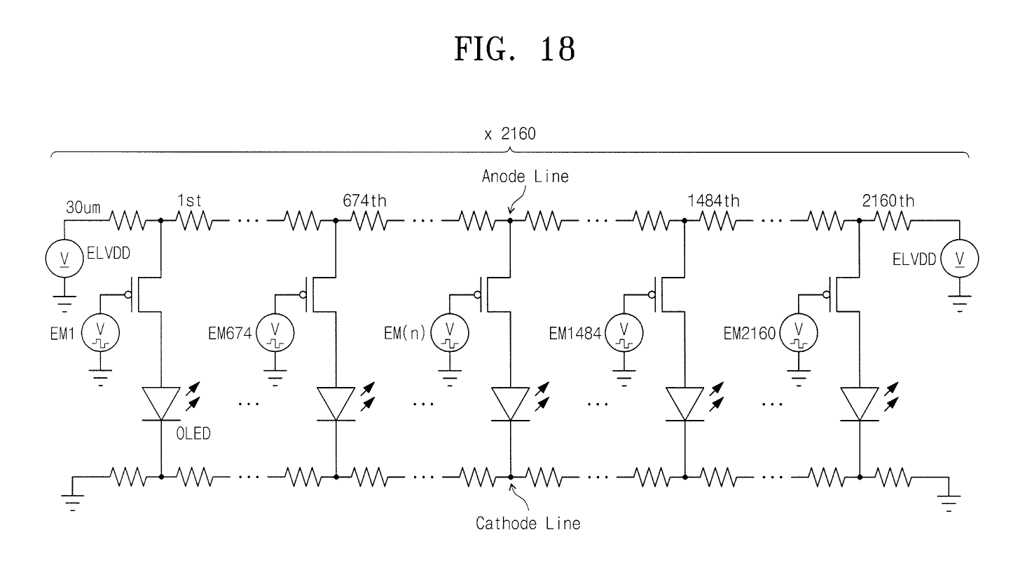

FIG. 18 illustrates an example of a pixel circuit in the case where the first power line ELVDD1 is not connected to the second power line ELVDD2 at the central portion of the active area 100 in the horizontal direction like the display circuit 10.

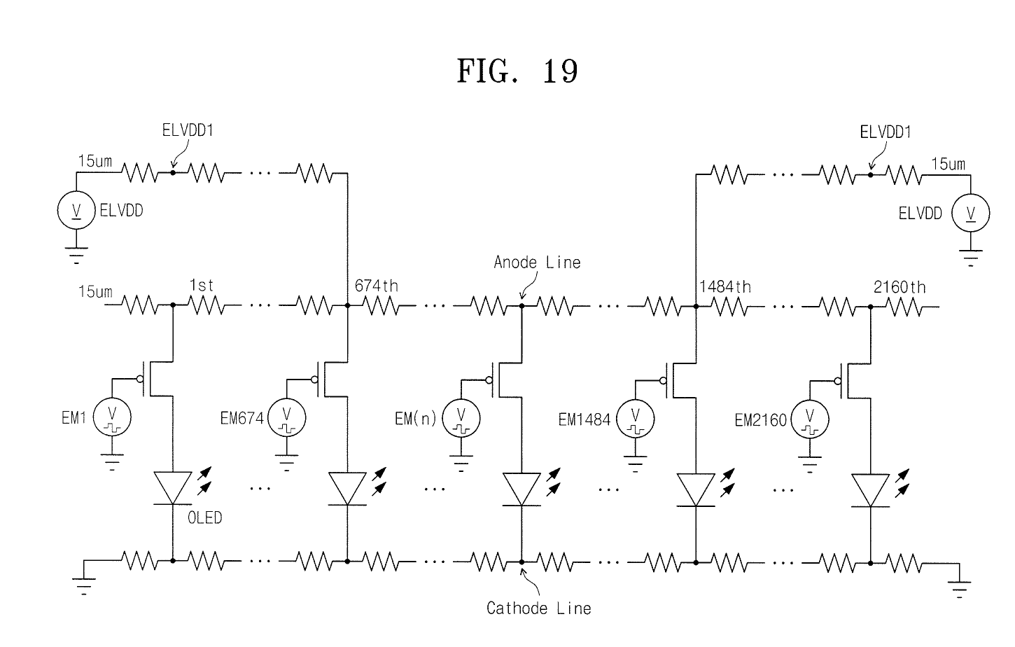

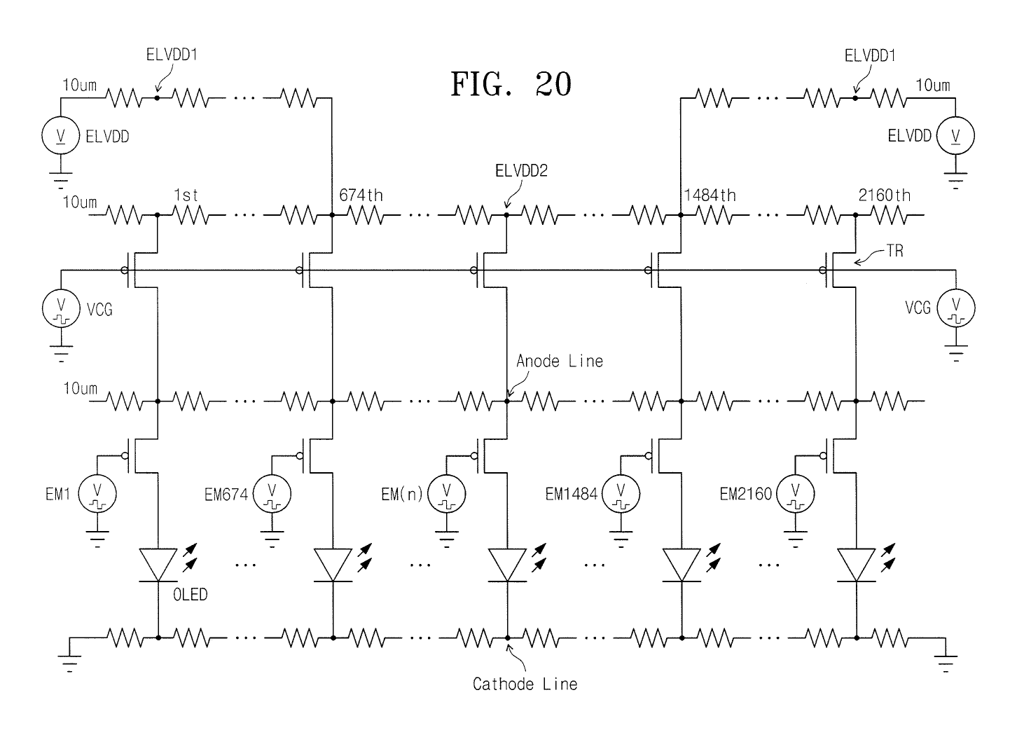

FIG. 19 illustrates an example of a pixel circuit in the case where the first power line ELVDD1 is connected to the second power line ELVDD2 at the central portion of the active area 100 in the horizontal direction. FIG. 20 illustrates an example of a pixel circuit in a case where the first power line ELVDD1 is connected to the second power line ELVDD2 at the central portion of the active area 100 in the horizontal direction and a transistor Tr is inserted as the filter circuit 110 to each pixel between the second power line ELCDD2 and the third power line ELVDD3 that is the anode line.

FIGS. 18 to 20 all illustrate the pixel circuit in which 2160 organic EL elements are provided in one row. FIGS. 19 and 20 illustrate a configuration in which the first power line ELVDD1 and the second ELVDD2 are connected at a position corresponding to a 674^{th} organic EL element and a 1484^{th} organic EL element from the left end.

The gate of each transistor Tr of the filter circuit 110 in the circuit in FIG. 20 is connected to a common control line 130. In addition, a resistance value of each transistor Tr of the filter circuit 110 is controlled by the common control line 130.

In addition, the line width of the anode line is 30 μm in FIG. 18, the line width of the power line ELVDD is 15 μm and the line width of the anode line is 15 μm in FIG. 19. The line width of the first power line ELVDD1 is 10 the line width of the second power line ELVDD2 is 10 μm, and the line width of the anode line is 10 μm in FIG. 20.

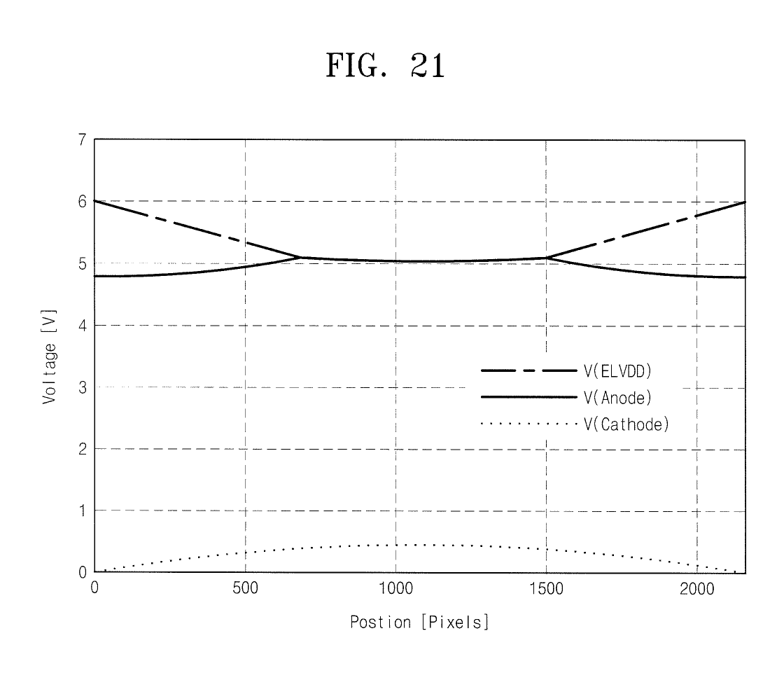

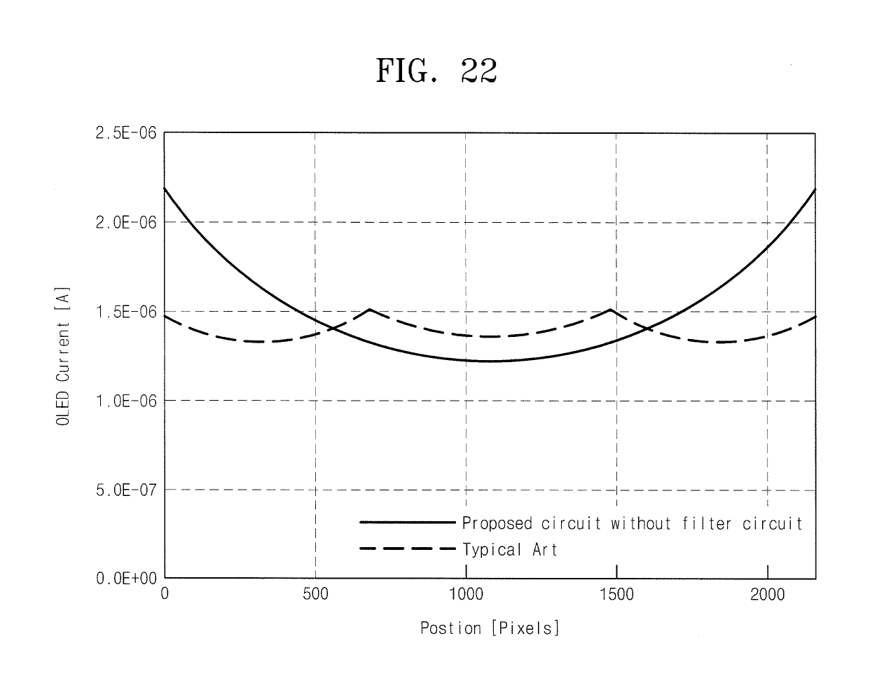

FIG. 21 is a graph illustrating an example of a distribution of a voltage applied to an organic EL element when the first power line ELVDD1 is connected to the second power line ELVDD2 like FIG. 19. FIG. 22 is a graph illustrating an example of a distribution of current flowing to an organic EL element when the first power line ELVDD1 is connected to the second power line ELVDD2 like FIG. 19.

In FIG. 21, the broken line corresponds to a distribution of the voltage applied to the power line, the solid line corresponds to a distribution of the voltage applied to the anode of the organic EL element, and a dotted line corresponds to a distribution of a voltage applied to a cathode line of the organic EL element. In FIG. 22, the broken line corresponds to a distribution of a current flowing to the organic EL element in a case where the first power line ELVDD1 is not connected to the second power line ELVDD2, and the solid line corresponds to a distribution of a current flowing to the organic EL element only when the first power line ELVDD1 is connected to the second power line ELVDD2.

When the first power line ELVDD1 is connected to the second power line ELVDD2, current deviation becomes smaller across the entire active area in comparison to the circuit configuration in FIG. 18. However, as represented in FIG. 21, a voltage variation amount of the anode line is large around a portion at which the first power line ELVDD1 is connected to the second power line ELVDD2.

In addition, as represented in FIG. 22, a current variation amount is also large around the portion at which the first power line ELVDD1 is connected to the second power line ELVDD2. The current distribution in FIG. 22 appears as a luminance distribution without change. Accordingly, as FIG. 19, when the first power line ELVDD1 is connected to the second power line ELVDD2, luminance unevenness may easily occur around the portion at which the first power line ELVDD1 is connected to the second power line ELVDD2.

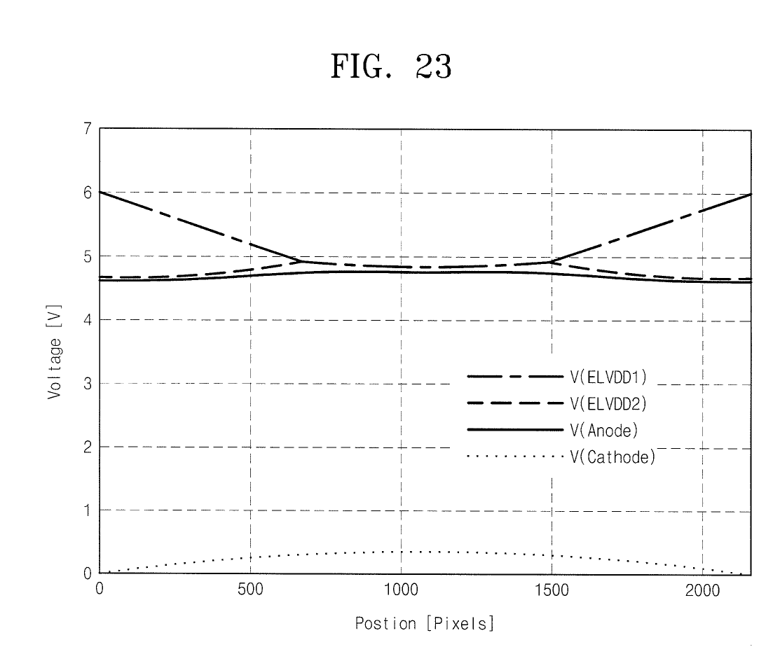

FIG. 23 is, like FIG. 20, a graph illustrating an example of a distribution of a voltage applied to the organic EL element when the first power line ELVDD1 is connected to the second power line ELVDD2, and the transistor Tr is inserted between the second power line ELVDD2 and the third power line ELVDD3 (see FIG. 20).

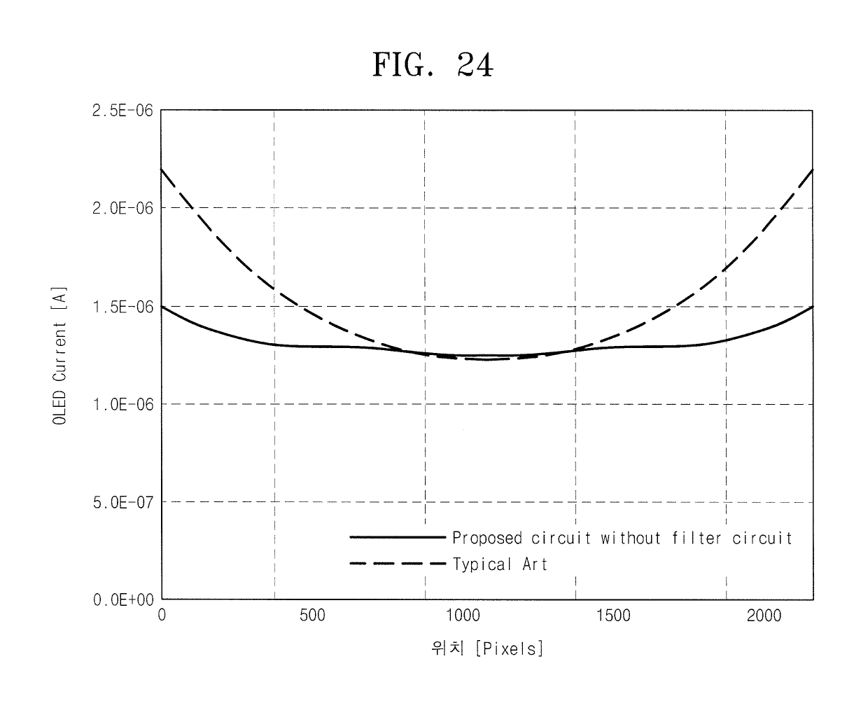

FIG. 24 is a graph illustrating an example of a distribution of a voltage applied to the organic EL element when the first power line ELVDD1 is connected to the second power line ELVDD2, and the transistor Tr is inserted between the second power line ELVDD2 and the third power line ELVDD3 (see FIG. 20).

In FIG. 23, the dashed dotted line represents a distribution of a voltage applied to the first power line ELVDD1, the broken line represents a distribution of a voltage applied to the second power line ELVDD2, the solid line represents a distribution of a voltage applied to the anode of the organic EL element, and the dotted line represents a distribution of a voltage applied to the cathode of the organic EL element.

In FIG. 24, the broken line is a distribution of a current flowing to an organic EL element when a transistor Tr is inserted between the second power lien ELVDD2 and the third power line ELVDD3. The solid line is a distribution of a current flowing to an organic EL element when a transistor Tr is inserted between the second power lien ELVDD2 and the third power line ELVDD3.

When the first power line ELVDD1 is connected to the second power line ELVDD2, and the transistor Tr is between the second power line ELVDD2 and the third power line ELVDD3 (see FIG. 20), a current deviation across the entire active area is small in comparison to the circuit configuration in FIG. 18. In addition, as represented in FIG. 23, the voltage variation around the portion at which the first power line ELVDD1 that is an anode line is connected to the second power line ELVDD2 is gradual in comparison to the circuit configuration in FIG. 19.

As represented in FIG. 24, the current variation amount around the portion at which the first power line ELVDD1 that is an anode line is connected to the second power line ELVDD2 is also gradual in comparison to the circuit configuration in FIG. 19. Accordingly, as FIG. 20, when the first power line ELVDD1 is connected to the second power line ELVDD2 and the transistor Tr is between the second power line ELVDD2 and the third power line ELVDD3, luminance unevenness does not easily occur around the portion at which the first power line ELVDD1 is connected to the second power line ELVDD2.

From the above-described, the voltage distribution of the power line ELVDD3 that is the anode line is able to be matched with the voltage distribution of the cathode line, by connecting the first power line ELVDD1 to the second power line ELVDD2 and inserting the filter circuit 110 between the second power line ELVDD2 and the third power line ELVDD3.

Also, the sum of the line width of the power line of the circuit configuration in FIG. 18 and the line width of each power line of the circuit configuration in FIG. 20 may be the same with 30 μm. Accordingly, as represented in FIG. 20, when the first to third power lines ELVDD1, ELVDD2, and ELVDD3 are provided, it is possible to match the voltage distribution of the third power line ELVDD3 that is an anode line to the voltage distribution of the cathode line without increasing the total sum of the line widths of the power lines.

When the transistor Tr is used as the filter circuit 110, the phenomenon may occur. In cases where the whole active area 100 emits a light and part of the active area 100 emits a light in a horizontal direction, the amount of current flowing to the organic EL element is changed if a voltage applied to a gate of the transistor Tr is not changed.

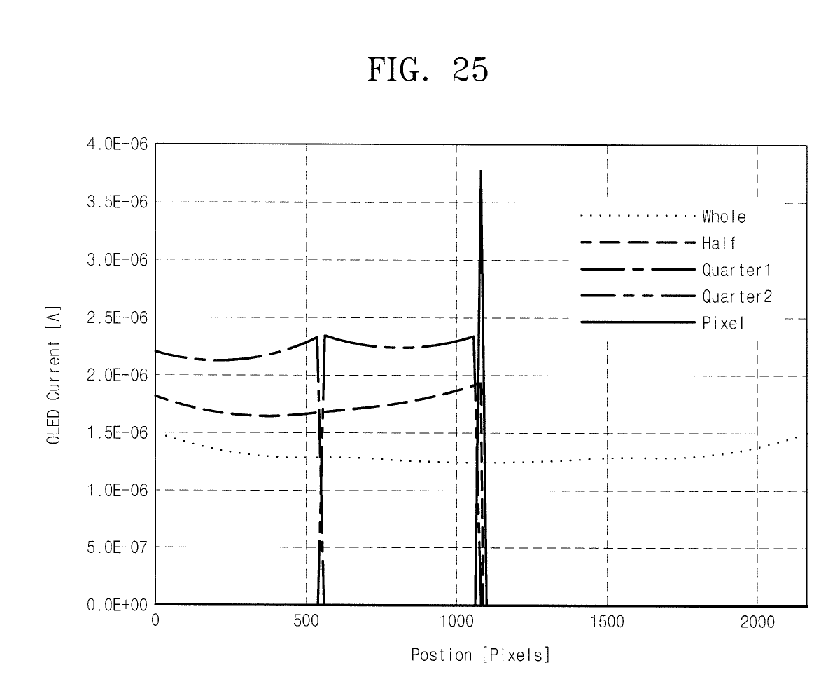

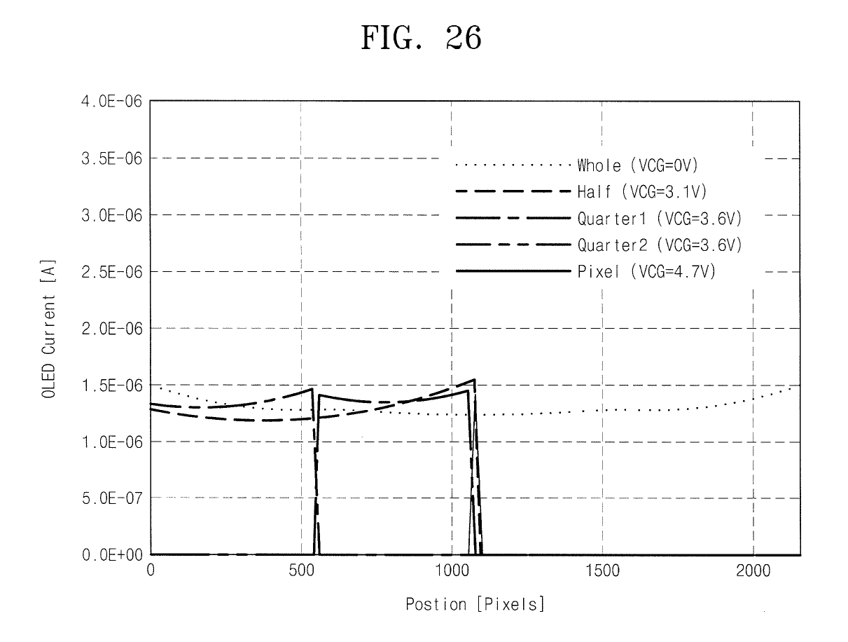

FIG. 25 is a graph illustrating an example of a distribution of a current flowing to the organic EL element when the first power line ELVDD1 is connected to the second power line ELVDD2, and the transistor Tr is inserted between the second power line ELVDD2 and the third power line ELVDD3 as illustrated in FIG. 20.

For example, FIG. 25 illustrates a current amount flowing to the organic EL element when the transistor Tr is used as the filter circuit 110 and a voltage applied to a gate of the transistor Tr is not changed by the size of a light emitting area. In FIG. 25, current amounts are illustrating as flowing to the organic EL element in cases where the whole light emitting area Whole, a half of the light emitting area Half, a quarter of the light emitting area Quarter 1 and 2, and only one pixel of the light emitting area Pixel emits a light.

As illustrated in FIG. 25, when the whole active area 100 emits a light and part of the active area 100 emits a light in a horizontal direction, a current amount flowing to the organic EL element is changed if a voltage applied to a gate of the transistor Tr is not changed. As the light emitting area is smaller, the current amount flowing to the organic EL element is greater. When the current amount flowing to the organic EL element becomes greater, a luminance of a pixel having the organic EL element becomes higher and the luminance of an image is rapidly changed.

In the present embodiment, when the transistor Tr is used as the filter circuit 110, a voltage applied to a gate of the transistor Tr is changed based on the size of the light emitting area. The current flowing to the transistor Tr may be controlled by changing a voltage applied to the gate of the transistor Tr. In addition, the luminance may be controlled almost constantly, regardless of the size of the light emitting area, by changing the voltage applied to the gate of the transistor Tr to control the current flowing through the transistor Tr. Control of the current flowing to the transistor Tr may be performed, for example, by the control line 130 in FIG. 1. The control line 130 is provided to change the voltage applied to the gate of the transistor Tr.

FIG. 26 is a graph illustrating an example of a distribution of current flowing to the organic EL device when the first power line ELVDD1 is connected to the second power line ELVDD2, and the transistor Tr is inserted between the second power line ELVDD2 and the third power line ELVDD3 as illustrated in FIG. 20. In FIG. 26, a current amount is illustrated to flow to the organic EL device when the transistor Tr is used as the filter circuit 110 and a voltage applied to a gate of the transistor Tr is changed by the size of the light emitting area. Similar to FIG. 25, FIG. 26 illustrates in a graph current amounts flowing to the organic EL element in cases where the whole light emitting area Whole, a half of the light emitting area Half, a quarter of the light emitting area Quarter 1 and 2, and only one pixel of the light emitting area Pixel emits a light.

When the whole light emitting area emits a light, the voltage VCG applied to the gate of the transistor Tr is 0 V. When a half of the light emitting area emits a light, the voltage VCG applied to the gate of the transistor Tr is 3.1V. When a quarter of the light emitting area emits a light, the voltage VCG applied to the gate of the transistor Tr is 3.6V. When only one pixel of the light emitting area emits a light, the voltage VCG applied to the gate of the transistor Tr is 4.7V.

As illustrated in FIG. 26, the current amount flowing to the organic EL element may be controlled to not change by changing the voltage applied to the gate of the transistor Tr according to the light emitting area of the active area 100.

Accordingly, when an image is displayed that is the size of the light emitting area is changed, the display circuit 10 according to at least one embodiment changes the voltage VCG applied to the gate of the transistor Tr to prevent the luminance from rapidly changing. In addition, when an image is displayed that is the size of the light emitting area is changed, the display circuit 10 according to at least one embodiment may restrict a rapid change of the luminance by setting the voltage VCG applied to the gate of the transistor according to the area of the light emitting area. Accordingly, once information on the light emitting area may be known, the value of voltage VCG is determined. Accordingly, the display circuit 10 may easily control the voltage VCG applied to the gate of the transistor Tr.

The display circuit 10 according to at least one embodiment uses the transistor Tr as the filter circuit 110, and changes the voltage applied to the gate of the transistor Tr by the size of the light emitting area. Accordingly, the display circuit 10 may control the current amount flowing to the organic EL element not to be changed regardless of the position of the light emitting area of the active area 100. Accordingly, the display circuit 10 may be enabled to control current flowing to the organic EL element by changing the voltage applied to the gate of the transistor Tr according to the size of the light emitting area, once the information on the light emitting area is known.

In accordance with one or more of the aforementioned embodiments, a voltage distribution of an anode line of an organic EL element may be substantially matched with a voltage distribution of a cathode line. This may be accomplished by providing the first power line ELVDD1 supplying power to the second power line ELVDD2 at the central portion in any one direction (e.g., a horizontal direction) of an active area and providing a filter circuit at an anode side of the organic EL element. The display circuit may therefore enable a voltage drop due to routing of a power line and reduction in luminance unevenness by providing the filter circuit to substantially match the voltage distribution of the anode line of the organic EL element to the voltage distribution of the cathode line.

In addition, due to reduction in the voltage drop due to routing of the power line, the display circuit may narrow the width of the power line and accordingly increase resolution and a pixel aperture ratio of the display device.

In addition, even though transistor Tr may be used as the filter circuit in one embodiment, the filter circuit may include other elements as long as it functions to substantially match the voltage distribution of the anode line of the organic EL element to the voltage distribution of the cathode line. For example, the filter circuit 110 may include a diode, a resistor, or a diode-connected transistor Tr.

In addition, in one or more of the foregoing embodiments, a reduction in the voltage drop due to routing of the power line and in luminance unevenness may be achieved by connecting power lines at the central portion of the active area for the power lines of the active area and by providing the filter circuit. In another embodiment, the lines between power lines ELVDD_R, ELVDD_G, and ELVDD_B in edge areas of FIG. 2 may undergo a voltage drop due to routing like the second power line ELVDD2 inside the active area. In this case, it is possible to reduce the voltage drop of the power line ELVDD_R in the boundary area by providing the filter circuit to the power lines ELVDD_R, ELVDD_G, and ELVDD_B of FIG. 2.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A voltage control circuit of a display device, comprising:
a first power line;
a second power line connected to the first power line at a central portion of a predetermined area;
a third power line in the predetermined area; and
a filter circuit between the second and third power lines, wherein the filter circuit includes at least one element having a larger resistance value per unit length than a resistance value per unit length of at least one of the second or third power lines.

2. The circuit as claimed in claim 1, wherein the first and second power lines are formed with an identical line layer.

3. The circuit as claimed in claim 1, wherein the first and third power lines are formed with different line layers.

4. The circuit as claimed in claim 1, wherein:
the first and second power lines are on an identical plane and contact only at a contact point, and
the first and third power lines are on different planes in an intersected manner.

5. The circuit as claimed in claim 1, wherein the element includes a transistor.

6. The circuit as claimed in claim 5, wherein:
the predetermined area is an active area for displaying an image, and
a voltage applied to a gate of the transistor is based on a light emitting area of the active area.

7. The circuit as claimed in claim 1, wherein:
the predetermined area is an active area for displaying an image, and
the central portion is between one end of the active area and a position spaced from the one end by substantially a quarter of a width of the active area.

8. The circuit as claimed in claim 1, wherein:
the predetermined area is an active area for displaying an image, and
the third power line is connected to a pixel circuit in a matrix form in the active area.

9. The circuit as claimed in claim 1, wherein the predetermined area is an area which includes periphery corner parts of the active area for displaying an image.

10. The circuit as claimed in claim 1, wherein the element includes a diode.

11. The circuit as claimed in claim 1, wherein the element includes a resistor.

12. The circuit as claimed in claim 1, wherein the element includes a transistor in a diode-connected state.

13. A display device, comprising:
a first power line;
a second power line connected to the first power line at a central portion of a predetermined area;
a third power line in the predetermined area;
a filter circuit between the second and third power lines, wherein the filter circuit includes at least one element having a larger resistance value per unit length than a resistance value per unit length of at least one of the second or third power lines; and
a pixel connected to the third power line.

14. An apparatus, comprising:
a first connection;
a second connection; and
a filter circuit between the first and second connections,
wherein the first connection connects the filter circuit to a first power line and the second connection connects the filter circuit to a second power line, and wherein the filter circuit includes at least one element having a larger resistance value per unit length than a resistance value per unit length of at least one of the first or second power lines.

15. The apparatus as claimed in claim 14, wherein:
the first connection includes a plurality of first lines,
the second connection includes a plurality of second lines, and
the second lines are connected to a respective number of pixel circuits.

16. The apparatus as claimed in claim 15, wherein a number of the first lines equals a number of the second lines.

17. The apparatus as claimed in claim 14, wherein the first connection is connected between the filter circuit and a third signal line in an active area for displaying an image.

18. The apparatus as claimed in claim 17, wherein the first connection is connected to the third signal line at substantially a central location of the active area.

19. The apparatus as claimed in claim 14, wherein the element includes a transistor.

20. The apparatus as claimed in claim 14, wherein the element includes a diode or resistor.
